(19) United States
(12) Patent Application Publication
(10) Pub. No.: US 2016/0351104 A1
(43) Pub. Date: Dec. 1, 2016

(54) APPARATUS AND METHOD FOR IMAGE RENDERING BASED ON WHITE POINT CORRECTION

(71) Applicant: Pixtronix, Inc., San Diego, CA (US)

(72) Inventors: Fahri Yaras, Chelsea, MA (US); Edward Buckley, Melrose, MA (US)

(21) Appl. No.: 14/726,147

(22) Filed: May 29, 2015

(51) Int. Cl. G09G 3/20

(52) U.S. Cl. CPC G09G 3/2081; G09G 3/2003; G09G 2300/0452; G09G 2320/0233; G09G 2320/0633; G09G 2320/064; G09G 2320/0666; G09G 2320/0673

(57) ABSTRACT

Systems, methods and apparatus, including computer programs encoded on computer storage media, of this disclosure allow for forming an image frame on a display device. In one aspect, a controller associated with a display device can be configured to correct for output white point shift due to variation, across separate color subfields of an image frame, in the respective number of subframes or the respective subframe weights. The controller can determine aggregate subframe weights for at least two color subfields and adjust at least one display parameter based on the determined aggregate subframe weights, to shift the output white point towards a white point of a target color gamut. The display parameter(s) can include a duty cycle of a color subfield, tristimulus coordinates of light used to illuminate a color subfield or gamut mapping function. The controller can display the image frame according to the adjusted display parameter(s).

### TECHNICAL FIELD

This disclosure relates to the field of displays, and in particular, to image formation processes used by displays.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, other micromachining processes or a combination thereof. Micromachining processes can etch away parts of substrates or deposited material layers, or can add layers to form electrical and electromechanical devices.

Display devices can generate images by controlling light emitted or reflected through each pixel of a display panel. Transmissive display devices such as EMS-based display devices include display elements that modulate light emitted from a backlight to generate an image. Reflective display devices selectively reflect light from the ambient or a front light to form an image.

### SUMMARY

The systems, methods and devices of this disclosure each have several innovative aspects, no single one of which is solely responsible for the desirable attributes disclosed herein.

One innovative aspect of the subject matter described in this disclosure can be implemented in a controller configured to receive first image data for a first image frame and generate, for each of a plurality of component colors, a respective number of first subframes based on the first image data. At least two component colors can be associated with different respective numbers of first subframes, such that the generated first subframes are associated with a first output white point. The controller can cause the generated first subframes to be displayed. The controller also can be configured to receive second image data for a second image frame and determine, for each of the plurality of component colors, a respective number of second subframes. For at least one component color of the plurality of component colors, the respective number of second subframes can be different than the respective number of first subframes for that component color. The controller can generate the second subframes based on the second image data, such that a second output white point associated with the second image frame is substantially the same as the first output white point. The controller can cause the generated second subframes to be displayed.

In some implementations, the plurality of component colors, for the generated second subframes, can be associated with substantially equal respective duty cycles. In some implementations, the plurality of component colors, for the generated second subframes, can be associated with substantially equal respective cumulative luminances.

In some implementations, in generating the second subframes, the controller can determine subframe weights for second subframes associated with each of the component colors, such that a first aggregate weight associated with a first component color is different than a second aggregate weight associated with a second component color. The controller can adjust at least one display parameter used to output the second image frame based on the first and second aggregate weights, such that the second output white point is shifted towards the first output white point. The controller can then generate the second subframes according to the identified numbers of subframes and the identified subframe weights.

The at least one display parameter can include, for instance, a duty cycle of the first component color. In such instance, the controller can adjust the duty cycle of the first component color determining a cumulative duty cycle for the first component color based on the first aggregate weight, determining a target cumulative duty cycle based on the first and second aggregate weights, computing a scaling factor for the first component color based on the cumulative duty cycle for the first component color and the target cumulative duty cycle, and determining display periods for second subframes associated with the first component color using the scaling factor.

The at least one display parameter can include, for instance, at least a chromaticity or luminance of light used to illuminate the first component color. In such instance, the controller can adjust a chromaticity or luminance of the contributing color associated with the first component color subfield by obtaining tristimulus values for light used to illuminate the first component color, computing a scaling factor based on the first and second aggregate weights, adjusting the tristimulus values for the light used to illuminate the first component color using the scaling factor, and identifying at least one light source intensity, for illuminating a second subframe associated with the first component color, based on the adjusted tristimulus values.

The at least one display parameter can include, for instance, a gamut mapping function applied to the second image data. In such instance, the controller can adjusting the gamut mapping function by determining tristimulus coordinates of the second output white point based on the first and second aggregate weights, obtaining tristimulus coordinates of a target output white point, computing scaling factors based on the tristimulus coordinates of the second output white point and the tristimulus coordinates of the target output white point, and transforming the second image data using a transformation formed based on the scaling factors.

In some implementations, the controller can include a processor capable of processing image data. The processor can be capable of communicating with a memory device and a display including a plurality of display elements. The controller can be capable of sending at least a portion of the image data to a driver circuit. The driver circuit can be capable of sending at least one signal to the display. The processor can be capable of receiving the image data from an image source module. The image source module can include at least one of a receiver, transceiver, and transmitter. The processor can be capable of receiving input data from an input device.

Another innovative aspect of the subject matter described in this disclosure can be implemented in a non-transitory computer-readable medium including computer code instructions stored thereon. The computer code instructions when executed can cause a processor to receive first image data for a first image frame and generate, for each of a plurality of component colors, a respective number of first subframes based on the first image data. At least two component colors can be associated with different respective numbers of first subframes, such that the generated first subframes are associated with a first output white point. The processor, responsive to execution of the computer code instructions, can cause the generated first subframes to be displayed. The processor, responsive to execution of the computer code instructions, can receive second image data for a second image frame and determine, for each of the plurality of component colors, a respective number of second subframes. For at least one component color of the plurality of component colors, the respective number of second subframes can be different than the respective number of first subframes for that component color. In response to execution of the computer code instructions, the processor also can generate the second subframes based on the second image data, such that a second output white point associated with the second image frame is substantially the same as the first output white point, and cause the generated second subframes to be displayed.

In some implementations, the plurality of component colors, for the generated second subframes, can be associated with substantially equal respective duty cycles. In some implementations, the plurality of component colors, for the generated second subframes, can be associated with substantially equal respective cumulative luminances.

In some implementations, in generating the second subframes, the processor can determine subframe weights for second subframes associated with each of the component colors, such that a first aggregate weight associated with a first component color is different than a second aggregate weight associated with a second component color. The processor can adjust at least one display parameter used to output the second image frame based on the first and second aggregate weights, such that the second output white point is shifted towards the first output white point. The processor can then generate the second subframes according to the identified numbers of subframes and the identified subframe weights.

In some implementations, the at least one display parameter can include a duty cycle of the first component color. In such implementations, the processor can adjust the duty cycle of the first component color by determining a cumulative duty cycle for the first component color based on the first aggregate weight, determining a target cumulative duty cycle based on the first and second aggregate weights, computing a scaling factor for the first component color based on the cumulative duty cycle for the first component color and the target cumulative duty cycle, and determining display periods for second subframes associated with the first component color using the scaling factor.

In some implementations, the at least one display parameter can include at least a chromaticity or luminance of light used to illuminate the first component color. In some implementations, the at least one display parameter can include a gamut mapping function applied to the second image data.

Another innovative aspect of the subject matter described in this disclosure can be implemented in a method for forming an image frame. The method can include receiving first image data for a first image frame and generating, for each of a plurality of component colors, a respective number of first subframes based on the first image data. At least two component colors can be associated with different respective numbers of first subframes, such that the generated first subframes are associated with a first output white point. The method can include causing the generated first subframes to be displayed. The method also can include receiving second image data for a second image frame and determining, for each of the plurality of component colors, a respective number of second subframes. For at least one component color of the plurality of component colors, the respective number of second subframes is different than the respective number of first subframes for that component color. The method also can include generating the second subframes based on the second image data, such that a second output white point associated with the second image frame is substantially the same as the first output white point, and causing the generated second subframes to be displayed.

In some implementations, the plurality of component colors, for the generated second subframes, can be associated with substantially equal respective duty cycles. In some implementations, the plurality of component colors, for the generated second subframes, can be associated with substantially equal respective cumulative luminances.

In some implementations, generating the second subframes can include (i) determining a number of subframes and subframe weights for each of the component colors, such that a first aggregate weight associated with a first component color is different than a second aggregate weight associated with a second component color, (ii) adjusting at least one display parameter used to output the second image frame based on the first and second aggregate weights, such that the second output white point is shifted towards the first output white point, and (iii) generating the second subframes according to the identified numbers of subframes and the identified subframe weights.

In some implementations, the at least one display parameter can include a duty cycle of the first component color. In such implementations, adjusting the duty cycle of the first component color can include (i) determining a cumulative duty cycle for the first component color based on the first aggregate weight, (ii) determining a target cumulative duty cycle based on the first and second aggregate weights, (iii) computing a scaling factor for the first component color based on the cumulative duty cycle for the first component color and the target cumulative duty cycle, and (iv) determining display periods for second subframes associated with the first component color using the scaling factor.

In some implementations, the at least one display parameter can include at least a chromaticity or luminance of light used to illuminate the first component color. In some implementations, the at least one display parameter can include a gamut mapping function applied to the second image data.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS)-based display apparatus.

FIG. 1B shows a block diagram of an example host device.

FIGS. 2A and 2B show views of an example dual actuator shutter assembly.

FIG. 3 shows a block diagram of an example display apparatus.

FIG. 4 shows a block diagram of example control logic suitable for use in the display apparatus shown in FIG. 3.

FIG. 5 shows a flow diagram of an example process of displaying an image frame involving correction for an output white point shift.

FIG. 6A shows a flow diagram of an example process of adjusting duty cycles of color subfields to shift an output white point towards a white point of a target color gamut.

FIG. 6B shows a diagram illustrating an example adjustment of duty cycles for red, green and blue color subfields.

FIG. 7 shows a flow diagram of an example process of adjusting a chromaticity or luminance of a contributing color associated with a color subfield of an image frame, to shift an output white point towards a white point of a target color gamut for the image frame.

FIG. 8 shows a flow diagram of an example process of adjusting a gamut mapping function applied to image data of an image frame, to shift an output white point towards a white point of a target color gamut for the image frame.

FIG. 9 shows a flow diagram of an example process of displaying image frames while enforcing similar respective output white points.

FIGS. 10A and 10B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smart books, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

When rendering an image frame, differences in aggregates subframe weights amongst the color subfields can result in a shift of the white point of the display (referred to us an “output white point”) away from a desired or target white point associated with a target color gamut. A display device controller can employ a display process configured to correct for shifts in the output white point by adjusting at least one display parameter used to output the image frame. In particular, the controller can adjust a duty cycle of a color subfield, the chromaticity or luminance of an illumination color associated with a color subfield or a gamut mapping function applied to image frame data in a way to shift the output point towards the target white point. Adjustment of the display parameter(s) can be based on at least two distinct aggregate subframe weights associated with at least two separate color subfields. For instance, the controller can scale the display parameter(s) using scaling factor(s) determined based on the at least two distinct aggregate subframe weights.

Particular implementations of the subject matter described in this disclosure can be implemented to realize one or more of the following potential advantages. In general, the display apparatus and processes disclosed herein mitigate white point shifts that may result from differences in the number of subframes or subframe weights used to display distinct color subfields. The image formation apparatus and processes disclosed herein also can mitigate other color shifts caused by the use of different numbers of subframes or different subframe weights when displaying distinct color subfields. As a result, the color fidelity of the display apparatus can be improved while energy consumption of the display can be reduced by using fewer subframes of one or more color subfields to form images.

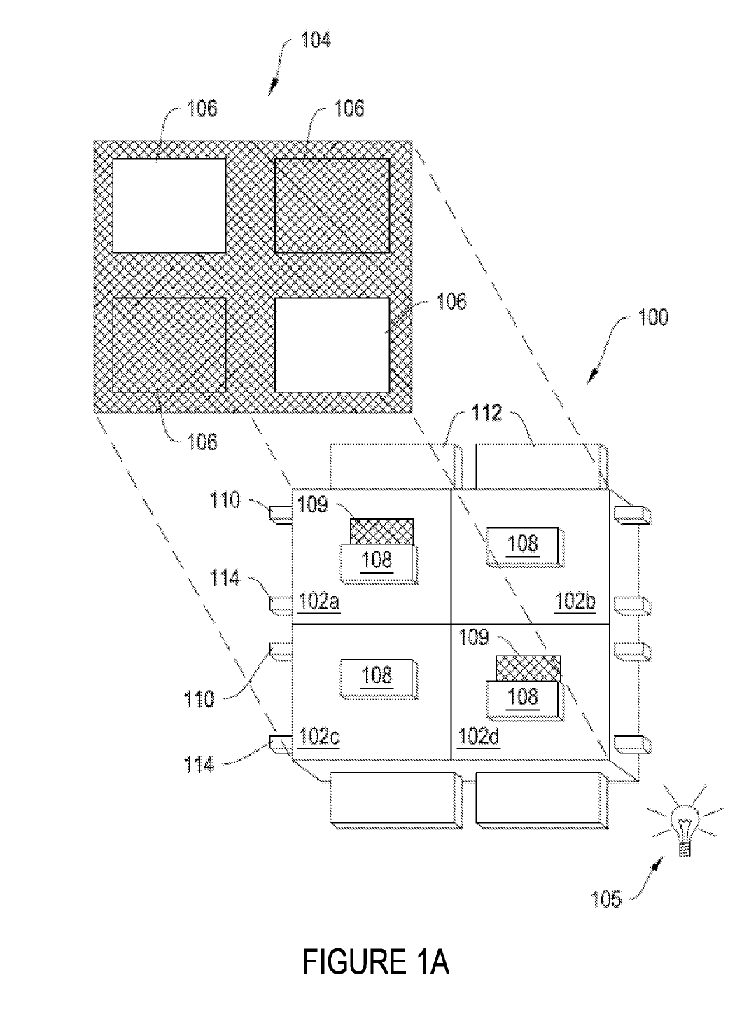

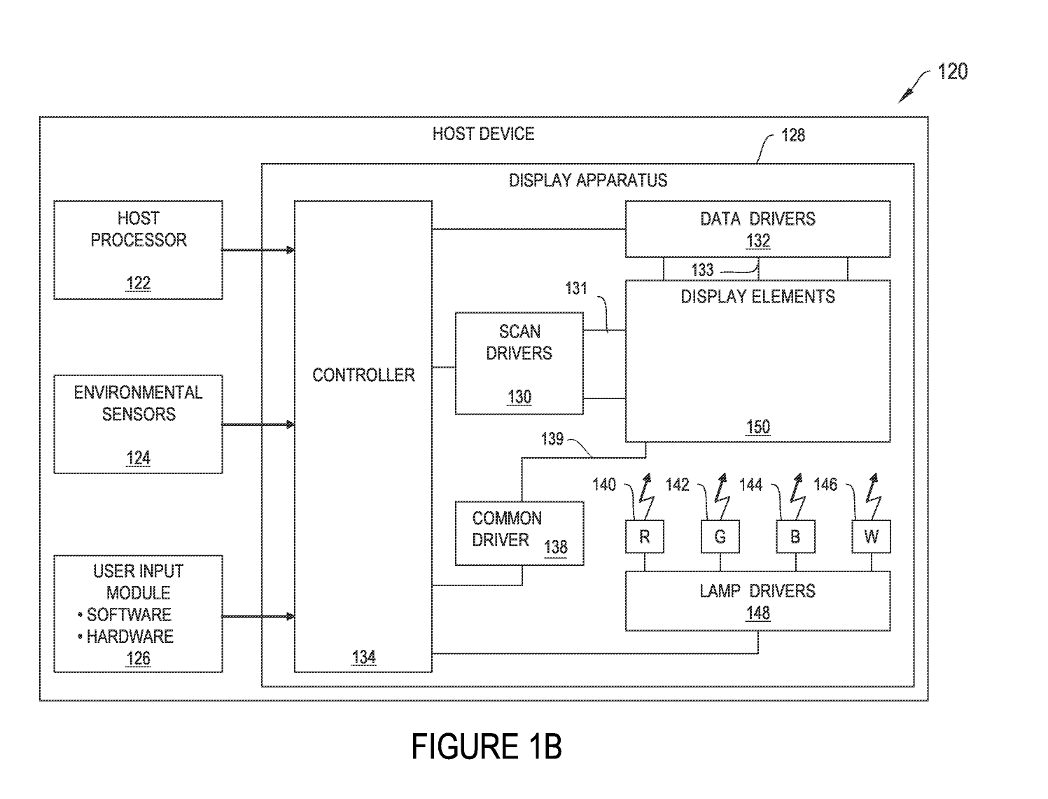

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a light guide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiple rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red (R), green (G), blue (B) and white (W) lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as R, G, B and W. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than R, G, B and W. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; or instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

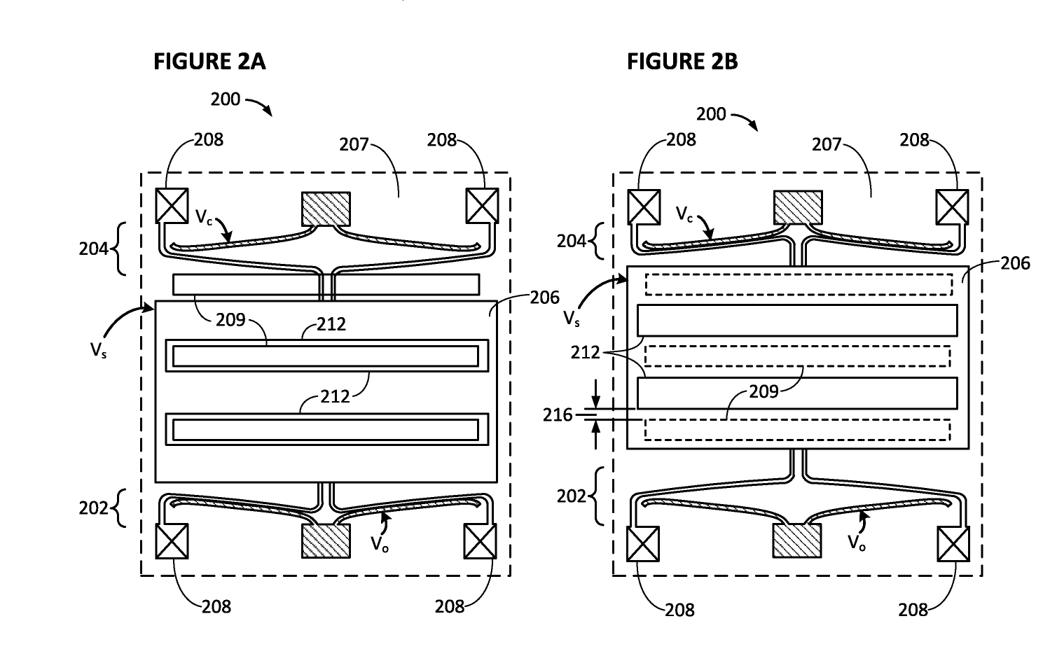

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

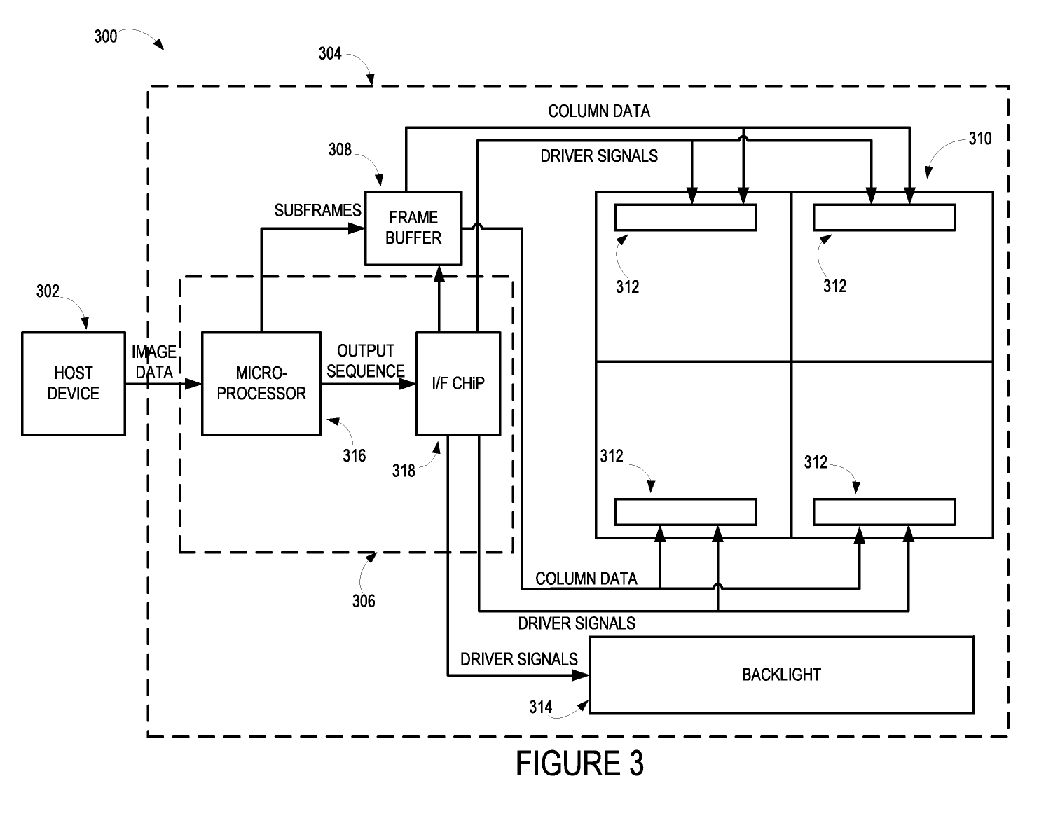

FIG. 3 shows a block diagram of an example display apparatus 300. The display apparatus 300 includes a host device 302 and a display module 304. The host device can be any of a number of electronic devices, such as a portable telephone, a smartphone, a watch, a tablet computer, a laptop computer, a desktop computer, a television, a set top box, a DVD or other media player, or any other device that provides graphical output to a display. In general, the host device 302 serves as a source for image data to be displayed on the display module 304.

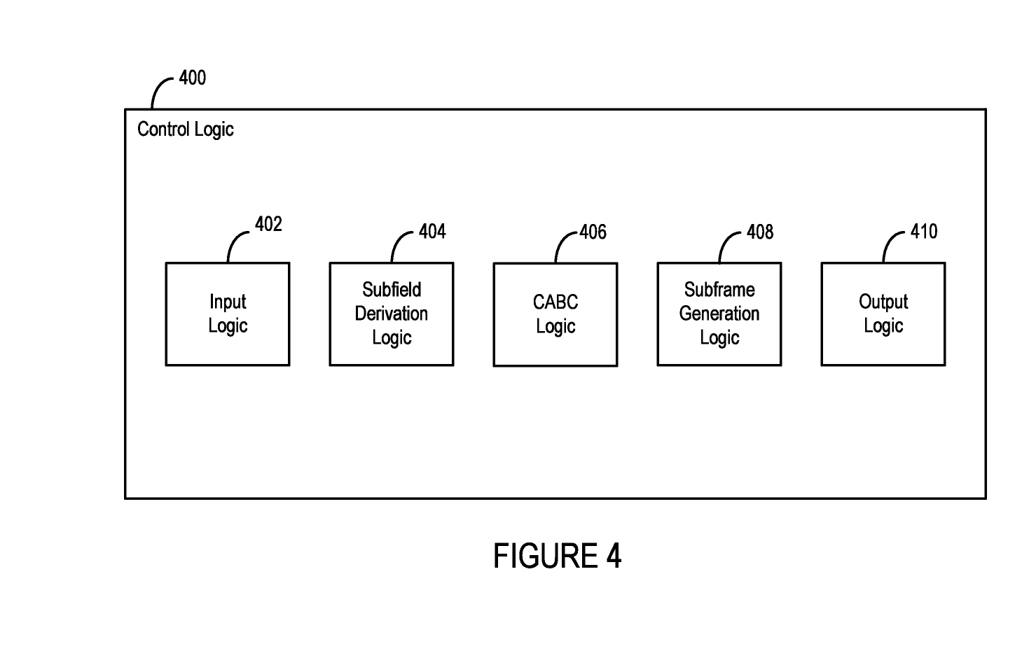

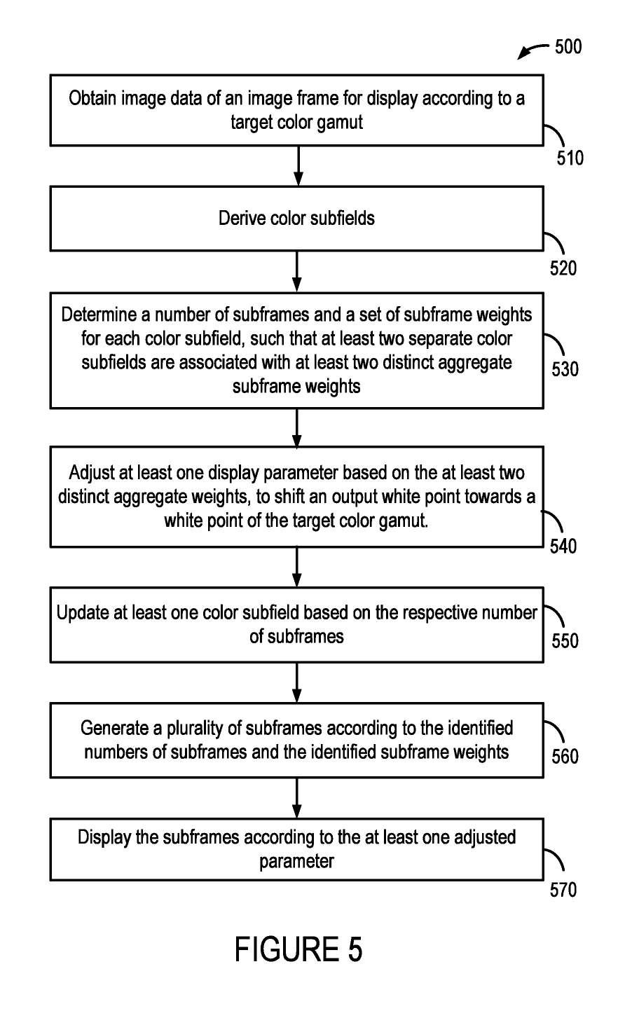

The display module 304 further includes control logic 306, a frame buffer 308, an array of display elements 310, display drivers 312 and a backlight 314. In general, the control logic 306 serves to process image data received from the host device 302 and controls the display drivers 312, array of display elements 310 and backlight 314 to together produce the images encoded in the image data. The functionality of the control logic 306 is described further below in relation to FIGS. 4 and 5.

In some implementations, as shown in FIG. 3, the functionality of the control logic 306 is divided between a microprocessor 316 and an interface (I/F) chip 318. In some implementations, the interface chip 318 is implemented in an integrated circuit logic device, such as an application specific integrated circuit (ASIC). In some implementations, the microprocessor 316 is configured to carry out all or substantially all of the image processing functionality of the control logic 306. In addition, the microprocessor 316 can be configured to determine an appropriate output sequence for the display module 304 to use to generate received images.

The microprocessor 316 can be configured to convert each color subfield into a corresponding set of image subframes, for instance bitplanes. Each image subframe can be associated with a color (color of the corresponding color subfield) and a weight, and includes desired states of each of the display elements in the array of display elements 310. The control logic 306 (or the microprocessor 316) can be configured to determine the number of image subframes to display to produce the image frame. The microprocessor 316 also can be configured to determine the order in which the image subframes are to be displayed and parameters associated with implementing the appropriate weight for each of the image subframes. These parameters may include, in various implementations, the duration for which each of the respective image subframes is to be illuminated and the intensity of such illumination. These parameters (i.e., the number of subframes, the order and timing of their output, and their weight implementation parameters for each subframe) can be collectively referred to as an “output sequence.”

The microprocessor 316 can be configured to correct for white point shifts that might occur as a result from displaying different color subfields using different numbers of subframes or different subframe weights. In some implementations, the microprocessor 316 can be configured to adjust one or more display parameters, to shift an output white point towards a white point of a target color gamut. Adjusting the display parameter(s) can include computing scaling factors based on aggregate subframe weights associated with distinct color subfields and scaling the display parameter(s) using the computed scaling factors. The display parameter(s) adjusted can include without limitation a duty cycle associated with a color subfield, chromaticity or luminance values of an illumination color associated with a color subfield or a gamut mapping function applied to image frame data.

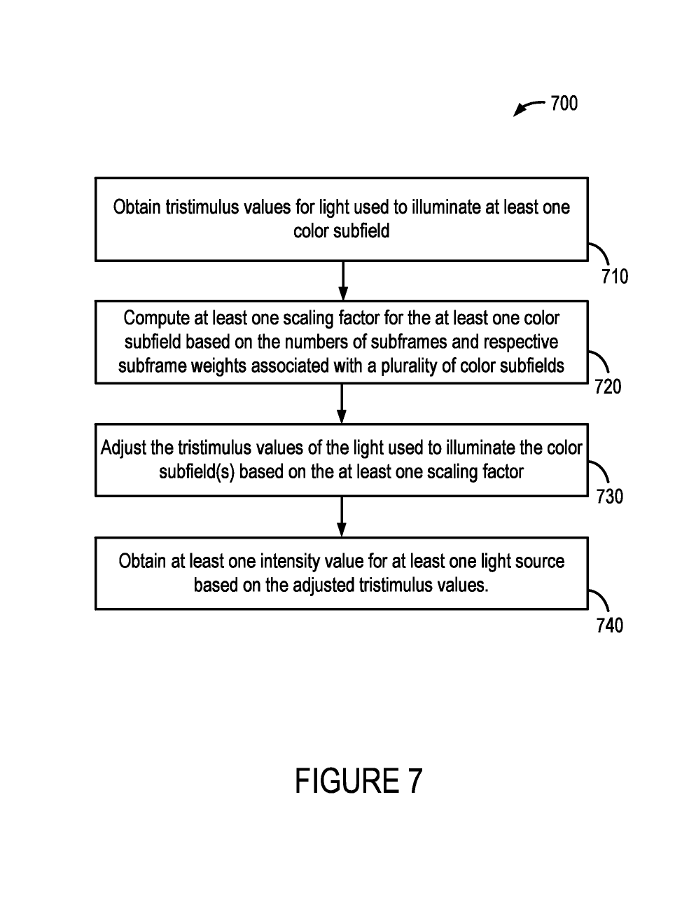

The interface chip 318 can be configured to carry out more routine operations of the display module 304. The operations may include retrieving image subframes from the frame buffer 308 and outputting control signals to the display drivers 312 and the backlight 314 in response to the retrieved image subframe and the output sequence determined by the microprocessor 316. The frame buffer 308 can be any volatile or non-volatile integrated circuit memory, such as DRAM, high-speed cache memory, or flash memory (for example, the frame buffer 308 can be similar to the frame buffer 28 shown in FIG. 7B). In some other implementations, the interface chip 318 causes the frame buffer 308 to output data signals directly to the display drivers 312.

In some other implementations, the functionality of the microprocessor 316 and the interface chip 318 are combined into a single logic device, which may take the form of a microprocessor, an ASIC, a field programmable gate array (FPGA) or other programmable logic device. For example, the functionality of the microprocessor 316 and the interface chip 318 can be implemented by a processor 21 shown in FIG. 7B. In some other implementations, the functionality of the microprocessor 316 and the interface chip 318 may be divided in other ways between multiple logic devices, including one or more microprocessors, ASICs, FPGAs, digital signal processors (DSPs) or other logic devices.

The array of display elements 310 can include an array of any type of display elements that can be used for image formation. In some implementations, the display elements can be EMS light modulators. In some such implementations, the display elements can be MEMS shutter-based light modulators similar to those shown in FIG. 2A or 2B. In some other implementations, the display elements can be other forms of light modulators, including liquid crystal light modulators, other types of EMS based light modulators, or light emitters, such as OLED emitters, configured for use with a time division gray scale image formation process.

The display drivers 312 can include a variety of drivers depending on the specific control matrix used to control the display elements in the array of display elements 310. In some implementations, the display drivers 312 include a plurality of scan drivers similar to the scan drivers 130, a plurality of data drivers similar to the data drivers 132, and a set of common drivers similar to the common drivers 138, all shown in FIG. 1B. As described above, the scan drivers output write enabling voltages to rows of display elements, while the data drivers output data signals along columns of display elements. The common drivers output signals to display elements in multiple rows and multiple columns of display elements.

In some implementations, particularly for larger display modules 304, the control matrix used to control the display elements in the array of display elements 310 is segmented into multiple regions. For example, the array of display elements 310 shown in FIG. 3 is segmented into four quadrants. A separate set of display drivers 312 is coupled to each quadrant. Dividing a display into segments in this fashion reduces the propagation time needed for signals output by the display drivers to reach the furthest display element coupled to a given driver, thereby decreasing the time needed to address the display. Such segmentation also can reduce the power requirements of the drivers employed. It also can allow for separate variation of actuation voltages applied to display elements.

In some implementations, the display elements in the array of display elements can be utilized in a direct-view transmissive display. In direct-view transmissive displays, the display elements, such as EMS light modulators, selectively block light that originates from a backlight, which is illuminated by one or more lamps. Such display elements can be fabricated on transparent substrates, made, for example, from glass. In some implementations, the display drivers 312 are coupled directly to the glass substrate on which the display elements are formed. In such implementations, the drivers are built using a chip-on-glass configuration. In some other implementations, the drivers are built on a separate circuit board and the outputs of the drivers are coupled to the substrate using, for example, flex cables or other wiring.

The backlight 314 can include a light guide, one or more light sources (such as LEDs), and light source drivers. The light sources can include light sources of multiple primary colors, such as red (R), green (G), blue (B), and in some implementations one or more of white (W), yellow (Y), cyan (C) and magenta (M). The light source drivers are configured to individually drive the light sources to a plurality of discrete light levels to enable illumination of gray scale or content adapted by content adaptive backlight control (CABC) in the backlight. The light guide can distribute the light output by light sources substantially evenly beneath the array of display elements 310. In some other implementations, for example for displays including reflective display elements, the display apparatus 300 can include a front light or other form of lighting instead of a backlight. The illumination of such alternative light sources can likewise be controlled according to illumination grayscale processes that incorporate content adaptive control features. For ease of explanation, the display processes discussed herein are described with respect to the use of a backlight. However, it would be understood by a person of ordinary skill in the art that such processes also may be adapted for use with a front light or other similar form of display lighting.

FIG. 4 shows a block diagram of example control logic 400 suitable for use as the control logic 306 in the display apparatus 300 shown in FIG. 3. More particularly, FIG. 4 shows a block diagram of functional modules, which, in some implementations, are executed by the microprocessor 316. Each functional module can be implemented as software in the form of computer executable instructions stored on a tangible computer readable medium, which can be executed by the microprocessor 316. In some implementations, one or more of the functional modules (or portions thereof) can be implemented in integrated circuit logic, such as an ASIC or FPGA. The control logic 400 includes input logic 402, subfield derivation logic 404, content adaptive backlight control (CABC) logic 406, subframe generation logic 408, and output logic 410. While shown as separate functional modules in FIG. 4, in some implementations, the functionality of two or more of the modules may be combined into one or more larger, more comprehensive modules or broken down into smaller more discrete modules.

The input logic 402 is configured to receive input image data as a stream of pixel intensity values, and present the pixel intensity values to other modules within the control logic 400. The subfield derivation logic 404 can derive color subfields (such as red (R), green (G), blue (B), white (W), yellow (Y), cyan (C), magenta (M) or any other color in the color gamut of the display module 304) based on the pixel intensity values. In some implementations, the subfield derivation logic 404 can be configured to determine a number of subframes and a set of subframe weights to be associated with each color subfield. In some implementations, the number of subframes or the subframe weights may vary from one color subfield to another. Such variation can result in the output white point of displayed image data shifting away from a white point of a target color gamut. The subfield derivation logic 404 (or output logic 410) can be configured to correct for such shift(s) by adjusting one or more display parameters, such as a duty cycle of a color subfield, tristimulus coordinates of a subfield color or a gamut mapping function. The subfield derivation logic 404 can be configured to adjust the display parameter(s) based on aggregate subframe weights associated with at least two color subfields.

The CABC logic 406 can be configured to scale the intensity of the output of light sources for each color subfield based on the maximum intensity values found in the subfield. The subframe generation logic 408 can generate subframes for each of the color subfields based on the output sequence and the pixel intensity values in the color subfield. The output logic 410 can coordinate with one or more of the other logic components to determine an appropriate output sequence, and then use the output sequence to display the subframes on the display.

In some implementations, when executed by the microprocessor 316, the components of the control logic 400, along with the interface chip 318, display drivers 312, and backlight 314 (such as those shown in FIG. 3), function to carry out a method for generating an image on a display, such as the process 500 shown in FIG. 5. The functionality of the components of the control logic 400 is described further in relation to various operations carried out as part of the process 500.

FIG. 5 shows a flow diagram of an example process 500 of displaying an image frame based on a target color gamut. In some implementations, the process 500 can be carried out by the control logic 400 (shown in FIG. 4). The process 500 includes obtaining image data of an image frame associated with a target color gamut (stage 510), deriving a plurality of color subfields based on the image data (stage 520), determining a number of subframes and corresponding subframe weights for each color subfield, such that at least two of the color subfields have different aggregate subframe weights (stage 530), adjusting at least one display parameter, used to display the image frame, based on the different aggregate subframe weights, to shift an output white point towards the white point of the target color gamut (stage 540), updating at least one color subfield based on the determined respective number(s) of subframes and their corresponding weights (stage 550), generating a set of image subframes for each color subfield according to the respective number of subframes and their respective subframe weights (stage 560), and causing the generated subframes to be displayed (stage 570).

Referring to FIGS. 3, 4 and 5, the process 500 includes obtaining image data of an image frame for display according to a target color gamut (stage 510). The image data can be obtained by the input logic 402. Typically, such image data is obtained by the input logic 402 as a stream of intensity values for the R, G, and B components of each pixel in the image frame. The intensity values are typically received as binary numbers. The image data may be received directly from an image source, such as from an electronic storage medium incorporated into the display apparatus 300 (or display apparatus 128 of FIG. 1B). Alternatively, it may be received from a host device 302 in which the display apparatus 300 is built. The target color gamut defines the color space that can be used in displaying the image frame. Examples of the target color gamut can include, but are not limited to, the standard RGB (sRGB) color gamut or the Adobe® RGB color gamut. In some implementations, the target color gamut can be different from the maximum achievable color gamut the display apparatus 300 is capable of reproducing referred to as the “display color gamut.”

In some implementations, the subfield derivation logic 404 (or the input logic 402) can be configured to preprocess the obtained image frame. For example, in some implementations, the image data includes color intensity values for more pixels or fewer pixels than are included in the display apparatus 300. In such cases, the input logic 402, the subfield derivation logic 404, or other logic incorporated into the control logic 400 can scale the image data appropriately to the number of pixels included in the display apparatus 300. In some implementations, the image frame data is received having been encoded assuming a given display gamma. In some implementations, if such gamma encoding is detected, logic within the control logic 400 applies a gamma correction process to adjust the pixel intensity values to be more appropriate for the gamma of the display apparatus 300. For example, image data is often encoded based on the gamma of a typical liquid crystal (LCD) display. To address this common gamma encoding, the control logic 400 may store a gamma correction lookup table (LUT) from which it can quickly retrieve appropriate intensity values given a set of LCD gamma encoded pixel values. In some implementations, the gamma correction LUT includes corresponding RGB intensity values having a 16 bit-per-color resolution, though other color resolutions such as 20 bit-per-pixel or 24 bit-per-pixel may be used in other implementations.

In some implementations, the image frame preprocessing includes a dithering stage. In some implementations, the process of de-gamma encoding an image results in 16 bit-per-color pixel values, even though the display apparatus 300 may not be configured for displaying such a large number of bits per color. A dithering process can help distribute any quantization error associated with converting these pixel values down to a maximum color resolution available to the display, such as 4, 5, 6, or 8 bits per color.

The subfield derivation logic 404 can be configured to derive a plurality of color subfields for displaying the image frame (stage 520). Each color subfield is associated with a respective color (also referred to as a “contributing” color) and includes the intensity values of all pixels in the image frame for that color. The subfield colors can include component colors such as the colors R, G, or B. In some implementations, the subfield colors R, G and B can correspond to the R, G and B colors defining the vertices of the target color gamut. The subfield colors can further include one or more composite colors. A composite color is a color generated by combining at least two component colors. For instance, composite colors can include colors such as, but not limited to, white (W), cyan (C), magenta (M), or yellow (Y). In some implementations, the subfield derivation logic 404 can use a composite color as a subfield color regardless of the color content of the image frame. In some implementations, the subfield derivation logic 404 can select one or more composite colors for use as subfield color(s) based on the color content of the image frame.

Given a set of subfield colors, the subfield derivation logic 404 can be configured to generate pixel intensity values for each selected subfield color for all pixels. The subfield derivation logic can first set pixel intensity values for the R, G and B colors, select pixel intensity values for any composite subfield colors, and then adjust the pixel intensity values for the R, G and B colors accordingly. For instance, in a case where a single composite subfield color is used, the subfield derivation logic 404 can first segregate the pixel intensity values for each of the R, G and G subfields and then adjust the pixel intensity values for these colors based on the color energy assigned to the composite subfield color. In some implementations, the subfield derivation logic 404 can determine the pixel intensity values for each color subfield using a lookup table (LUT). The LUT can be configured to map RGB pixel intensities in the received (or preprocessed) image data to respective pixel intensities in each of the color subfields. The LUT can be viewed as implementing a gamut mapping function that maps pixel intensities associated with the received (or preprocessed) image frame data to a color gamut whose vertices are defined by characteristics of the subfield colors associated with the R, G and B color subfields. In some implementations, other processing stages such as gamma correction can be incorporated within the gamut mapping function. That is, the mapping represented by the LUT or the gamut mapping function also can result in gamma correction.

The process 500 includes the subfield derivation logic 404 determining a number of subframes and a respective set of subframe weights for each color subfield, such that at least two color subfields are associated with unequal aggregate subframe weights (stage 530). Each subframe is associated with a respective subframe weight. For each color subfield, its respective aggregate subframe weight can be equal to the sum of all the subframe weights associated with that color subfield. A subframe weight can be indicative of the illumination energy associated with the respective subframe. Similarly, the aggregate subframe weight associated with a respective color subfield can be indicative of the illumination energy associated with that color subfield. The illumination energy for a color subfield depends on the duty cycle of that color subfield and the intensities of the light sources used to illuminate the same color subfield.

In some implementations, the subfield derivation logic 404 can determine the number of subframes and the respective subframe weights to use for each color subfield based on one or more factors, such as a display mode, color content of the image frame, color content of a previous frame, ambient light, display settings associated with the display apparatus 300, characteristics of the human visual system (HVS) or a combination thereof. In some implementations, the number of subframes or the respective set of subframe weights can vary from one color subfield to another. For instance, the HVS is more sensitive to green than to blue. As such, the subfield derivation logic 404 can allocate more, or a greater number of, gray scale levels to the G color subfield than that allocated to the B color subfield, for instance, by assigning a larger number of subframes or larger subframe weights to the G color subfield compared to the B color subfield. Also, the subfield derivation logic 404 can allocate more subframes or higher subframe weights to a B color subfield compared to other color subfields in an image frame having predominantly blue color content. Allocating more subframes or larger subframe weights to a given color subfield compared to other color subfields can result in finer quantization granularity for pixel intensities associated with the given color subfield compared to pixel intensities associated with the other color subfields. Accordingly, color intensities associated with the given color subfield are displayed with greater details than color intensities associated with the other color subfields.

The number of subframes and the respective subframe weights used for each color subfield can influence the image quality of the displayed image frame as well as the amount of energy consumed to display the image frame. For instance, when using a binary coding scheme (where subframe weights are equal to powers of two), a 8-bit scheme (i.e., employing eight bit-planes) can provide a better quantization accuracy of color intensities than a 4-bit scheme. However, the 8-bit scheme results in higher energy consumption than the 4-bit scheme. In some implementations, energy consumption can be driven by the process for loading image data into the array of display elements 150 (shown in FIG. 1B), the process of actuating the display elements 150, and the illumination of light sources (such as light sources 140, 142, 144 and 146 shown in FIG. 1B). As such, energy consumption by the display apparatus 300 can be reduced by reducing the number of subframes or decreasing the duty cycle or the light source illumination intensities associated with one or more color subfields.

In some implementations, the subfield derivation logic 404 can be configured to allocate different aggregate subframe weights (for example, by allocating different numbers of subframes or different subframe weights) to separate color subfields to enhance power efficiency or to enhance perceived image quality. For instance, by reducing the number of subframes or decreasing the subframe weights for a given color subfield (for example, a color subfield associated with a color to which the HVS is less sensitive than other subfield colors or a subfield color with less presence in the image frame), the subfield derivation logic 404 can reduce power consumption while maintaining high (or at least satisfactory) perceived image quality. Also, by increasing the aggregate subframe weight for a first color subfield such as a color subfield associated with a subfield color to which the HVS is more sensitive than other subfield colors or a subfield color with high presence in the image frame) when reducing the aggregate subframe weight for a second color subfield, the subfield derivation logic 404 can refine the quantization of the pixel intensities associated with the first color subfield.

However, allocating different aggregate subframe weights to separate color subfields can lead, in some implementations, to image artifacts such as a shifted output white point. For instance, if the R, G and B color subfields are associated with different respective maximum intensity values due to variation in respective aggregate subframe weights, the color displayed when all three colors are at their maximum intensity will not match the white point of the target color gamut. For example, the displayed color may be yellowish-white if the aggregate subframe weight for the B color subfield is smaller than that for the G and R color subfields. Also, the color displayed when the R, G and B color subfields are at their maximum intensity may be perceived as light cyan if the aggregate subframe weight for the R color subfield is smaller than that for the G and B color subfields. In some implementations, allocating different aggregate subframe weights to separate color subfields can further lead to shifts associated with other colors besides white. For example, a yellow color may be perceived as a greenish-yellow or orange depending on the relative aggregate subframe weights for the G and R color subfields.

The process 500 can include the subfield derivation logic 404 or the output logic 410 adjusting at least one display parameter based on the at least two distinct aggregate subframe weights, to shift the output white point towards the white point of the target color gamut (stage 540). In some implementations, the output logic 410 can correct for the output white point shift by adjusting the duty cycle of at least one color subfield. For instance, if the R, G and B light sources 140, 142 and 144 are driven at similar intensity levels, the output logic 410 can scale the duty cycle(s) such that the adjusted duty cycles for the R, G and B color subfields are substantially equal. In some implementations, the output logic 410 can determine or compute the duty cycle (instead of adjusting a default duty cycle value) of the at least one color subfield based on the at least two distinct aggregate subframe weights. In some implementations, the subfield derivation logic 404 or the output logic 410 can determine or adjust the at least one display parameter based on a given white point. For instance, the subfield derivation logic 404 or the output logic 410 can be configured to determine or adjust the at least one display parameter such that the output white point is equal to (or within a difference range from) a specific white point.

In some implementations, the output logic 410 can correct for the output white point shift by adjusting the chromaticity or luminance (which can be measured by XYZ tristimulus values of the color) of the light used to illuminate at least one color subfield (also referred to as the “illumination color” of the at least one color subfield). Adjusting the tristimulus values of the light illuminating a color subfield results in a shift of the output white point. The output logic 410 can be configured to adjust the tristimulus values of the subfield color(s) such that a shift of the output white point towards the white point of the target color gamut is introduced. In some implementations, the output logic 410 can determine or compute the chromaticity or luminance (instead of adjusting respective default values) of the light used to illuminate the at least one color subfield based on the at least two distinct aggregate subframe weights.

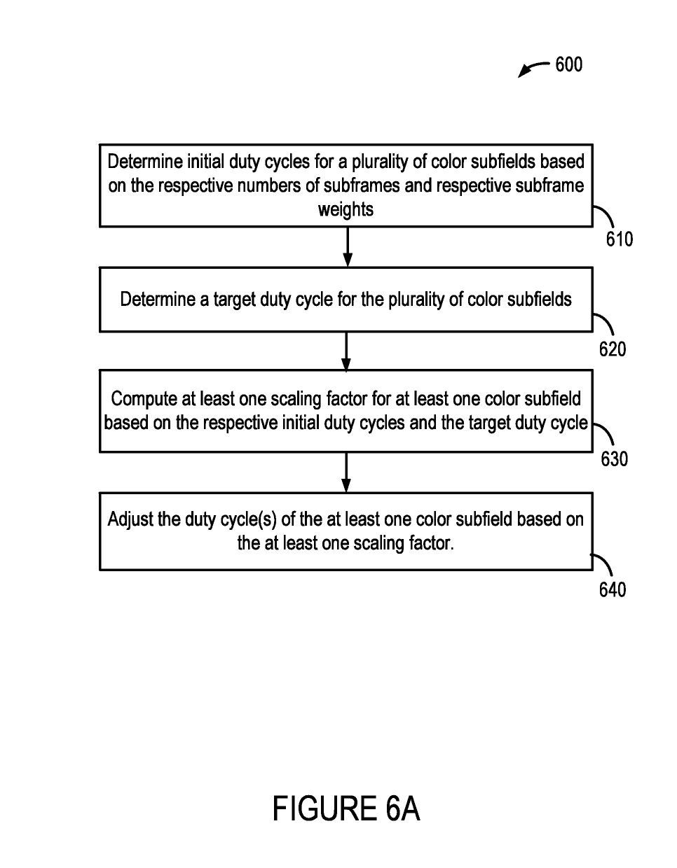

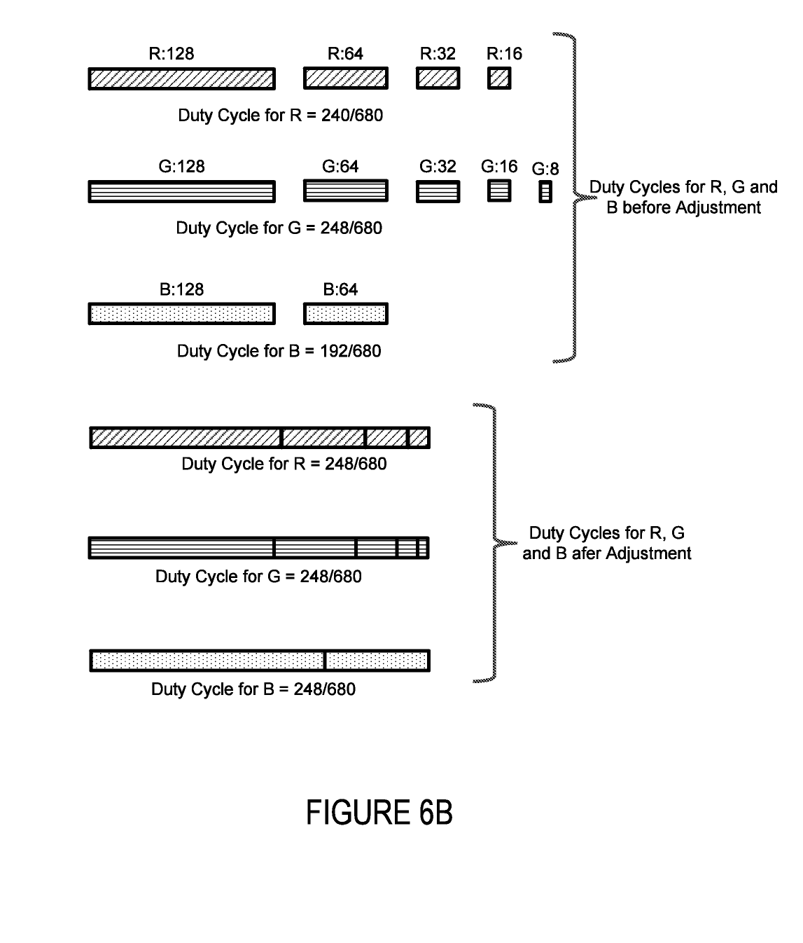

In some implementations, the subfield derivation logic 404 can correct for the output white point shift by adjusting pixel intensity values associated with at least one color subfield. For instance, the subfield derivation logic 404 can adjust the pixel intensity values for the color subfield(s) based on the tristimulus values of the output white point and the tristimulus values of the white point of the target color gamut such that a shift of the output white point towards the white point of the target color gamut is introduced. Example implementations of the above process for adjusting display parameter(s) (stage 540) are discussed below with regard to FIGS. 6A, 6B, 7 and 8.

FIG. 6A shows a flow diagram of an example process 600 of adjusting duty cycles of color subfields to shift an output white point towards a white point of a target color gamut. The process 600 includes determining initial duty cycles for a plurality of color subfields based on the respective numbers of subframes and respective subframe weights of each color subfield (stage 610) determining a common target duty cycle for the plurality of color subfields (stage 620), computing at least one scaling factor for at least one of the color subfields based on the respective initial duty cycle(s) and the common target duty cycle (stage 630), and adjusting the duty cycle(s) for the at least one color subfield based on the at least one scaling factor (stage 640).

FIG. 6B shows a diagram illustrating an example adjustment of duty cycles for red, green and blue color subfields. In particular, the diagram in FIG. 6B shows example duty cycles for R, G and B color subfields as well as the subframes associated with each of these color subfields before and after applying duty cycle adjustment.

Referring to FIGS. 4, 6A and 6B, the process 600 includes the output logic 410 determining the initial duty cycles for a plurality of color subfields (such as the R, G and B color subfields) based on the number of subframes and the subframe weights associated with each of the color subfields. In some implementations, the output logic 410 can compute the aggregate subframe weight for each color subfield and then determine the duty cycle for each color subfield based on the respective aggregate subframe weight. For instance, for each of the R, G and B color subfields, the output logic 410 can compute the respective aggregate subframe weights W_{R}, W_{G} and W_{B} as the sum of the weights of the subframes in each of these color subfields

$${W}_{R} = {\sum }_{i = 1}^{{N}_{R}} {w}_{R , i} , {W}_{G} = {\sum }_{i = 1}^{{N}_{G}} {w}_{G , i} , and {W}_{B} = {\sum }_{i = 1}^{{N}_{B}} {w}_{B , i} . \qquad ( 1 )$$

The integers N_{R}, N_{G} and N_{B} represent the number of subframes in the R, G and B color subfields, respectively. The variables W_{R,i}, W_{G,i} and W_{B,i} represent the subframe weights in the R, G and B color subfields, respectively, and i is a subframe index.

For example, the aggregate subframe weight for the R color subfield in FIG. 6B is computed as W_{R}=128+64+32+16=240. The aggregate subframe weight for the G color subfield is computed as W_{G}=128+64+32+16+8=248, and the aggregate subframe weight for the B color subfield is computed as W_{B}=128+64=192. Once the aggregate subframe weights are computed, the output logic 410 can compute the duty cycle for a given color subfield based on a time unit T, where T represents the illumination time for a subframe with a subframe weight equal to one (or a unit weight). In FIG. 6B, the duty cycles for the R, G and B color subfields before duty cycle adjustment are

$${C}_{R} = \frac{240}{( 240 + 248 + 192 )} , {C}_{G} = \frac{248}{( 240 + 248 + 192 )} and {C}_{B} = \frac{192}{( 240 + 248 + 192 )} ,$$

respectively, where C_{R}, C_{G} and C_{B} represent the duty cycles for R, G and B color subfields, respectively. In some implementations, the output logic 410 can use a lookup table (LUT) to determine the duty cycles of the color subfields based on the respective aggregate subframe weights.

The process 600 includes the output logic 410 determining a target duty cycle for the plurality of color subfields (stage 620). In some implementations, the target duty cycle can be equal to one of the initial (for example, non-adjusted) duty cycles of the color subfields. The output logic 410 can select the target duty cycle to be equal to largest initial duty cycle, the smallest initial duty cycle, or any other initial duty cycle in between or among the initial duty cycles of the plurality of color subfields. For instance, in the example of FIG. 6B, the target duty cycle is selected to be equal to the largest initial duty cycle among the initial duty cycles of the R, G and B color subfields (which is equal to the duty cycle of the G color subfield).

The process 600 also includes the output logic 410 computing a scaling factor for at least one color subfield based on the determined initial duty cycles and the target duty cycle. In some implementations, the scaling factor for a given color subfield can be equal to the target duty cycle C_{target} divided by the initial duty cycle for that color subfield. For example

$${S}_{R} = \frac{{C}_{target}}{{C}_{R}} , {S}_{G} = \frac{{C}_{target}}{{C}_{G}} and {S}_{B} = \frac{{C}_{target}}{{C}_{B}} . \qquad ( 2 )$$

The variables S_{R}, S_{G} and S_{B} represent the scaling factors for the R, G and B color subfields, respectively. For instance, the scaling factors for the R, G and B color subfields described in FIG. 6B can be computed as

$${S}_{R} = \frac{248}{240} , {S}_{G} = \frac{248}{248} and {S}_{B} = \frac{248}{192} ,$$

respectively. The output logic 410 can compute scaling factors for all the color subfields or just for a subset thereof. For example, since the target duty cycle is equal to the initial duty cycle of the G color subfield, the output logic 410 can compute scaling factors for the R and B color subfields (the scaling factor for the G color subfield is known to be equal to one). In some implementations, the output logic 410 can compute the scaling factors for color subfields with initial duty cycles that are different from the target duty cycle by more than a threshold difference (for example at least about 1% different).

The process 600 also includes the output logic 410 adjusting the duty cycle(s) for the at least one color subfield based on the computed scaling factor(s). In some implementations, the output logic 410 can multiply the initial duty cycle for a given color subfield by the respective scaling factor to obtain the corresponding adjusted duty cycle. In such implementations, the scaling factors can be defined (or computed) in a way such that after the duty cycle adjustment, the R, G and B color subfields have equal duty cycles. In FIG. 6B, the duty cycles for the R, G and B color subfield after the duty cycle adjustment are all equal to the target duty cycle. In some implementations, the scaling factors can be defined (or computed) in a way such that after the duty cycle adjustment, the R, G and B color subfields are associated with substantially equal duty cycles. For instance, the scaling factors can be defined in a way such that the final duty cycles (i.e., after adjustment) for separate color subfields are within a threshold difference from the target duty cycle. In some implementations, the threshold difference can be, for example, about 1% of the target duty cycle.

In some implementations, a composite color subfield (such as a W, Y, C or M color subfield) can be used with R, G and B color subfields to display the image frame. If the W color subfield is used with the R, G and B color subfields, the subfield derivation logic 404 can adjust the duty cycles for the R, G and B color subfields as described above and can keep the duty cycle for the W color subfield un-adjusted. The duty cycle of the W color subfield can be ignored when determining the duty cycles of the R, G and B color subfields. In some implementations, other composite color subfields (such as the Y, C or M color subfield(s)) can be used with the R, G and B color subfields to display the image frame. In such implementations, the output logic 410 can further adjust the duty cycle(s) of such color subfields and the RGB color subfields based on the aggregate subframe weights of the composite color subfield.

FIG. 7 shows a flow diagram of an example process 700 of adjusting a chromaticity or luminance of the illumination color of a color subfield of an image frame to shift an output white point towards a target white point. The target white point can be a white point of a target color gamut for the image frame, a white point associated with one or more previous image frames, a white point associated with an ambient condition or a white point associated with a display mode. The process 700 includes obtaining tristimulus values for the light associated with at least one color subfield (stage 710), computing at least one scaling factor for the at least one color subfield based on the numbers of subframes and subframe weights associated with a plurality of color subfields (stage 720), adjusting the tristimulus values of illumination light for the at least one subfield color associated with the at least one color subfield based on the computed scaling factor(s) (stage 730), and obtaining at least one light source intensity for at least one light source used to generate illumination light having the adjusted tristimulus values (stage 740).

Referring to FIGS. 4 and 7, the process 700 includes the output logic 410 obtaining tristimulus values for at least one component color (such as the R, G and B subfield colors) associated with at least one color subfield (stage 710). In some implementations, the tristimulus values can be associated with the R, G and B colors defining the vertices of the target color gamut. The target color gamut can be fixed (for example, equal to the sRGB color gamut or the Adobe® RGB color gamut) for all image frames, and, as such, the tristimulus values can be stored in a memory component accessible to the controller 134 shown in FIG. 1B. In some implementations, the target color gamut may vary based on information (for example, ambient light levels) from environmental sensors 124 (shown in FIG. 1B), a display mode, display settings, or other factors. In such implementations, the output logic 410 can be configured to determine the tristimulus values based on such factors.

The process 700 also includes the output logic 410 computing at least one scaling factor for the at least one color subfield based on the numbers of subframes and subframe weights associated with a plurality of color subfields (stage 720). In some implementations, the output logic 410 can compute the aggregate subframe weight for each of the plurality of color subfields based on the respective number of subframes and the respective subframe weights and then compute the scaling factor(s) based on the computed aggregate subframe weights. For instance, for each of the R, G and B color subfields, the output logic 410 can compute the respective aggregate subframe weights W_{R}, W_{G} and W_{B} as the sum of the subframe weights in each of these color subfields (as shown in first equation above).

In some implementations, the output logic 410 can then compute the scaling factors S_{R}, S_{G} and S_{B} for the R, G and B color subfields, respectively, as

$${S}_{R} = \frac{min ( {W}_{R} , {W}_{G} , {W}_{B} )}{{W}_{R}} , {S}_{G} = \frac{min ( {W}_{R} , {W}_{G} , {W}_{B} )}{{W}_{G}} and {S}_{B} = \frac{min ( {W}_{R} , {W}_{G} , {W}_{B} )}{{W}_{B}} . \qquad ( 3 )$$

In some implementations the subfield derivation logic 404 can compute the scaling factor(s) for the color subfield(s) associated with aggregate subframe weight(s) that are not within a threshold difference compared to the target aggregate subframe weight (such as min(W_{R}, W_{G}, W_{B})). In such implementations, the subfield derivation logic 404 can adjust the tristimulus values of the contributing colors associated with color subfields having aggregate subframe weights that are not within the threshold difference compared to the target aggregate subframe weight. In some implementations, the threshold difference can be, for example, about 2%, 4% or 5% of the target aggregate subframe weight.

In some implementations, a composite color subfield (such as the W, Y, C or M color subfield) can be used to display the image frame. If the W color subfield is used with the R, G and B color subfields, the subfield derivation logic 404 can compute the scaling factors for R, G and B color subfields as described above and can keep the tristimulus coordinates for the W contributing color un-adjusted. In some implementations, other composite color subfields (such as the Y, C or M color subfield(s)) can be used with the R, G and B color subfields to display the image frame. In such implementations, computing the scaling factors can further include accounting for the aggregate subframe weight(s) of the composite color subfield(s). For instance, in the case where the R, G, B and Y color subfields are used, the scaling factors for the R, G and B color subfields can be computed as

$$\begin{matrix}{S}_{R} = \frac{min ( min ( {W}_{R} , {W}_{G} ) , {W}_{Y} , {W}_{B} )}{{W}_{R}} , & ( 4 a ) \\ {S}_{G} = \frac{min ( min ( {W}_{R} , {W}_{G} ) , {W}_{Y} , {W}_{B} )}{{W}_{G}} , and & ( 4 b ) \\ {S}_{B} = \frac{min ( min ( {W}_{R} , {W}_{G} ) , {W}_{Y} , {W}_{B} )}{{W}_{B}} , & ( 4 c )\end{matrix}$$

where W_{Y} represents the aggregate subframe weight for the Y color subfield.

The process 700 also includes the output logic 410 adjusting the tristimulus values of the illumination light color(s) based on the computed scaling factor(s) (stage 730). In some implementations, the output logic 410 can adjust the tristimulus values of one or more contributing colors as,

$$X = \frac{α \times S \times {X}_{initial}}{f} , Y = \frac{α \times S \times {Y}_{initial}}{f} and Z = \frac{α \times S \times {Z}_{initial}}{f} . \qquad ( 5 )$$

The variables Xᵢₙᵢₜᵢₐₗ, Yᵢₙᵢₜᵢₐₗ and Zᵢₙᵢₜᵢₐₗ represent the initial (i.e., non-adjusted) tristimulus coordinates for a given contributing color and the variables X, Y and Z represent the corresponding adjusted tristimulus coordinates for the contributing color. The variables α, f and S represent a CABC factor, a duty cycle adjustment and the scaling factor, respectively, for the color subfield. The CABC factor α represents a scaling factor employed by the CABC logic 406 to scale the intensity of the output of light sources for each color subfield based on the maximum intensity values found in the subfield. The CABC factor α can vary from one color subfield to another. The duty cycle adjustment f can be defined as the ratio of the initial duty cycle for a color subfield divided by the respective adjusted duty cycle for the same color subfield. In some implementations, the output logic 410 can scale the tristimulus coordinates by the scaling factor S. In equation (5) above, the CABC factor α and the duty cycle adjustment f may be substantially the same (for example, with little variation such as 1% variation) or substantially different across the R, G and B color subfields.

Considering the R, G and B color subfields shown in FIG. 6B, the aggregate subframe weights for the R, G and B color subfields are W_{R}=240, W_{G}=248, and W_{B}=192, respectively. The duty cycle adjustments for the R, G and B color subfields are f_{R}=1.02, f_{G}=1.71, and f_{B}=0.66, respectively. The output logic 410 can compute the scaling factors (using equation (3)) for the R, G and B color subfields as

$${S}_{R} = \frac{192}{240} = 0.8 , {S}_{G} = \frac{192}{248} = 0.77 , and {S}_{B} = \frac{192}{192} = 1.0 ,$$

respectively. For initial tristimulus coordinates (Xᵢₙᵢₜᵢₐₗ, Yᵢₙᵢₜᵢₐₗ, Zᵢₙᵢₜᵢₐₗ) for the R, G and B colors equal to (305, 135, 3), (155, 424, 67), and (104,35,577), respectively, and the CABC factor equal to 1 (α=1), the output logic 410 can compute the respective adjusted tristimulus coordinates (X_{R,adj}, Y_{R,adj}, Z_{R,adj}) for the R component color using equation (5) as

$${X}_{R , adj} = \frac{1 \times 0.8 \times 305}{1.02} , {Y}_{R , adj} = \frac{1 \times 0.8 \times 135}{1.02} and {Z}_{R , adj} = \frac{1 \times 0.8 \times 3}{1.02} .$$

The output logic 410 can also compute the respective adjusted tristimulus coordinates (X_{G,adj}, Y_{G,adj}, Z_{G,adj}) for the G component color as

$${X}_{G , adj} = \frac{1 \times 0.77 \times 155}{1.71} , {Y}_{G , adj} = \frac{1 \times 0.77 \times 424}{1.71} and {Z}_{G , adj} = \frac{1 \times 0.77 \times 67}{1.71} ,$$

and the respective adjusted tristimulus coordinates (X_{B,adj}, Y_{B,adj}, Z_{B,adj}) for the B component color as

$${X}_{G , adj} = \frac{1 \times 1.0 \times 104}{0.66} , {Y}_{G , adj} = \frac{1 \times 1.0 \times 35}{0.66} and {Z}_{G , adj} = \frac{1 \times 1.0 \times 577}{0.66} ,$$

The process 700 also includes the output logic 410 obtaining light source intensities for illuminating each of the color subfields based on the computed tristimulus values (stage 740). The subfield derivation logic 404 can obtain the light source intensities using one or more lookup tables (LUTs), each of which maps tristimulus coordinates of an illumination color to respective intensities of one or more light sources. In some implementations, the subfield colors R, G and B can be less saturated than the R, G and B colors of the light sources 140, 142 and 144 shown in FIG. 1B. In such implementations, each of the R, G and B color subfields can be illuminated by two or more light sources of different colors. For instance, the R color subfield can be illuminated using the light sources 140, 142 and 144 shown in FIG. 1B, such that a substantially higher intensity is associated with the red light source 140 compared to the green and blue light sources 142 and 144. Using the LUTs, the subfield derivation logic 404 (or the output logic 410) can determine the light sources and the respective intensities to be used for illuminating each of the color subfields.

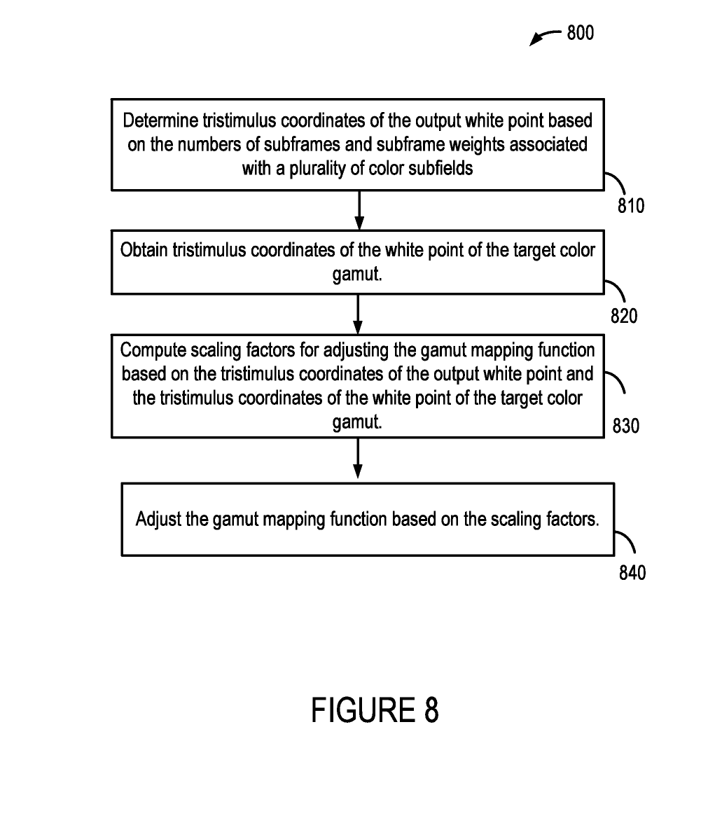

FIG. 8 shows a flow diagram of an example process 800 of adjusting a gamut mapping function applied to image data of an image frame, to shift an output white point towards a white point of a target color gamut for the image frame. The process 800 includes determining the tristimulus coordinates of the output white point based on the numbers of subframes and respective subframe weights associated with a plurality of color subfields (stage 810), obtaining the tristimulus coordinates of the white point of the target color gamut (stage 820), computing scaling factors for adjusting the gamut mapping function based on the tristimulus coordinates of the output white point and those of the white point of the target color gamut (stage 830), and adjusting the image gamut mapping function based on the computed scaling factors (stage 840).

The process 800 includes the subfield derivation logic 404 determining the tristimulus coordinates of the output white point based on the numbers of subframes and respective subframe weights associated with a plurality of color subfields (stage 810). In some implementations, the subfield derivation logic 404 can determine (or compute) the tristimulus coordinates of the output white point by determining the maximum grayscale values for the R, G and B color subfields and computing the tristimulus coordinates of the determined maximum grayscale values. The subfield derivation logic 404 can compute the maximum grayscale values for each of the R, G and B color subfields based on the number of subframes and subframe weights associated with that color subfield. In some implementations, the maximum grayscale value for a given color subfield is equal to the aggregate subframe weight of that color subfield. In some implementations, the maximum grayscale value for a given color subfield is equal to the aggregate subframe weight of that color subfield multiplied by a scalar. In computing the tristimulus coordinates of the output white point, the subfield derivation logic 404 can multiply the maximum grayscale values for the R, G and B color subfields by an n-primary to XYZ transfer matrix M. The matrix M represents a mapping from the RGB color space to the XYZ color space. The matrix can vary based on the color gamut. If the vector

$$m = [ \begin{matrix}max ( R ) \\ max ( G ) \\ max ( B )\end{matrix} ] ,$$

includes the maximum gray scale values max(R), max(G) and max(B) for the R, G and B color subfields, respectively, the tristimulus coordinates of the output white point can be computed as the multiplication of m by M (i.e., ρₒᵤₜₚᵤₜ=M·m). In some implementations, the output white point may be defined in terms of the maximum grayscale values of other color subfields (such as the W, Y, C, or M color subfields) besides the R, G and B color subfields. For instance, if the R, G, B and Y color subfields are used to display an image frame, the vector m can be computed as

$$m = [ \begin{matrix}max ( R ) + max ( Y ) \\ max ( G ) + max ( Y ) \\ max ( B )\end{matrix} ] ,$$

where max(Y) represents the maximum grayscale value for the Y color subfield.

The process 800 includes the subfield derivation logic 404 obtaining the tristimulus coordinates of the white point of the target color gamut (stage 820). The subfield derivation logic 404 can obtain such tristimulus coordinates from a memory component accessible to the controller 134 shown in FIG. 1B (for instance, if the target color gamut is fixed across separate image frames). In some implementations, the subfield derivation logic 404 can determine the tristimulus coordinates of the white point of the target color gamut based on one or more factors, such as ambient light, a display mode or display settings associated with the display apparatus 300 shown in FIG. 3. In the following, the tristimulus coordinates of the white point of the target color gamut is denoted by the vector ρ_{target}.

The process 800 includes the subfield derivation logic 404 computing scaling factors for adjusting the gamut mapping function based on the tristimulus coordinates of the output white point and those of the white point of the target color gamut (stage 830). That is, the subfield derivation logic can adjust the he gamut mapping function (or the LUT) used to determine pixel intensities for each color subfield based on the tristimulus coordinates of the output white point and those of the target white point. In some implementations, the subfield derivation logic 404 can be configured to compute three scaling factors corresponding to X, Y and Z tristimulus coordinates. The subfield derivation logic 404 can compute the scaling factors corresponding to the X, Y and Z tristimulus coordinates as equal to the ratios

$$\frac{{ρ}_{target} ( X )}{{ρ}_{output} ( X )} , \frac{{ρ}_{target} ( Y )}{{ρ}_{output} ( Y )} and \frac{{ρ}_{target} ( Z )}{{ρ}_{output} ( Z )} ,$$

respectively, where ρ_{target}(X), ρ_{target}(Y) and ρ_{target}(Z) represent the X, Y and Z coordinates of the white point of the target color gamut and ρₒᵤₜₚᵤₜ(X), ρₒᵤₜₚᵤₜ(Y) and ρₒᵤₜₚᵤₜ(Z) represent the X, Y and Z coordinates of the output white point. In some implementations, the subfield derivation logic 404 can further scale the ratios above with scalars between 0 and 1 to obtain the corresponding scaling factors.

The process 800 further includes the subfield derivation logic 404 adjusting the image gamut mapping function based on the computed scaling factors (stage 840). In some implementations, the subfield derivation logic 404 can form a linear transformation defined by the matrix H,

$$H = [ \begin{matrix}\frac{{ρ}_{target} ( X )}{{ρ}_{output} ( X )} & 0 & 0 \\ 0 & \frac{{ρ}_{target} ( Y )}{{ρ}_{output} ( Y )} & 0 \\ 0 & 0 & \frac{{ρ}_{target} ( Z )}{{ρ}_{output} ( Z )}\end{matrix} ] , \qquad ( 6 )$$

and incorporate the linear transformation into the gamut mapping function. That is, the transformation H can be incorporated in the LUT used to determine the pixel intensities for each color subfield. In other words, given an initial (for example, non-adjusted or default) gamut mapping function (or LUT), the corresponding adjusted gamut mapping function further includes (besides any processing stages associated with the initial gamut mapping function) a processing step of transforming tristimulus values of pixel intensities according to the linear transformation defined by the matrix H. In some implementations, the subfield derivation logic 404 can generate a new LUT based on a default LUT such that the new LUT incorporates the transformation defined by the matrix H. In some implementations, the subfield derivation logic 404 can apply the transformation defined by the matrix H on pixel by pixel basis.

For an image from associated with the sRGB color gamut and having maximum gray scale values max(R), max(G) and max(B) equal to 240, 248 and 224, respectively, the subfield derivation logic 404 can compute tristimulus coordinates of the corresponding output white point as

$${ρ}_{output} = M \cdot m = \frac{1}{256} [ \begin{matrix}0.4121 & 0.3577 & 0.1804 \\ 0.2125 & 0.7154 & 0.0721 \\ 0.0193 & 0.1192 & 0.9499\end{matrix} ] [ \begin{matrix}240 \\ 248 \\ 224\end{matrix} ] = [ \begin{matrix}0.8879 \\ 0.9561 \\ 0.9633\end{matrix} ] , where M = \frac{1}{256} [ \begin{matrix}0.4121 & 0.3577 & 0.1804 \\ 0.2125 & 0.7154 & 0.0721 \\ 0.0193 & 0.1192 & 0.9499\end{matrix} ] .$$

If the tristimulus coordinates of the white point of the target color gamut ρ_{target}(X), ρ_{target}(Y) and ρ_{target}(Z) are equal to 0.9085, 0.9561, and 1.0406, respectively (referred to as the D65 white point), the subfield derivation logic 404 can compute the transformation H, based on equation (6), as

$$H = [ \begin{matrix}\frac{0.9085}{0.8879} & 0 & 0 \\ 0 & \frac{0.9561}{0.9561} & 0 \\ 0 & 0 & \frac{1.0406}{09633}\end{matrix} ] = [ \begin{matrix}1.0232 & 0 & 0 \\ 0 & 1 & 0 \\ 0 & 0 & 1.0802\end{matrix} ] .$$

Referring back to FIGS. 3, 4 and 5, the process 500 includes the subfield derivation logic 404 updating at least one color subfield based on the respective number of subframes (stage 550). The subfield derivation logic 404 can apply dithering to pixel intensities of a color subfield. In some implementations, dithering can help diffuse (or spread) artifacts associated with pixel value quantization. For instance, for a color subfield, the smaller the number of subframes used, the more significant (or more perceptible) the quantization artifacts can be. Applying dithering (such as a vector error diffusion process) can diffuse quantization error. In some implementations, the subfield derivation logic 404 can apply the transformation defined by the matrix H on a pixel by pixel basis as part of stage 550.

The process 500 includes the subframe generation logic 408 generating a number of image subframes for each color subfield according to the respective number of subframe and the respective subframe weights (stage 560). Each subframe corresponds to a particular time slot in a time division gray scale image output sequence. It includes a desired state of each display element in the display for that time slot. In each time slot, a display element can take either a non-transmissive state or one or more states that allow for varying degrees of light transmission. In some implementations, the generated subframes include a distinct state value for each display element in the array of display elements 310 shown in FIG. 3.

In some implementations, the subframe generation logic 408 uses a code word lookup table (LUT) to generate the subframes. In some implementations the code word LUT stores series of binary values referred to as code words that indicate corresponding series of display element states that result in given pixel intensity values. The value of each digit in the code word indicates a display element state (for example, light or dark) and the position of the digit in the code word represents the subframe weight that is to be attributed to the state. In some implementations, the subframe weights are assigned to each digit in the code word such that each digit is assigned a subframe weight that is twice the weight of a preceding digit. In some other implementations, multiple digits of a code word may be assigned the same weight. In some other implementations, each digit is assigned a different weight, but the weights may not all increase according to a fixed pattern, digit to digit.

To generate a set of subframes, the subframe generation logic 408 obtains code words for all pixels in a color subfield. The subframe generation logic 408 can aggregate the digits in each of the respective positions in the code words for the set of pixels in the subfield together into subframes. For example, the digits in the first position of each code word for each pixel are aggregated into a first subframe. The digits in the second position of each code word for each pixel are aggregated into a second subframe, and so forth. The LUT(s) used to generate the subframes can be set for a maximum number of subframes. In a case where less than the maximum number of subframes is used for a given color subfields (for example, k out of N maximum subframes are used), the digits associated with the k+1 to N least significant positions are ignored. The subframes, once generated, can be stored in the frame buffer 308 shown in FIG. 3 or sent to output logic 410.

The output logic 410 causes the generated sets of subframes to be displayed according the adjusted display parameter(s) (stage 570). The output logic 410 can be configured to control output signals to a remainder of the components of the display apparatus 300 to cause the generated image subframes to be displayed. In some implementations, the output logic 410 can be configured to cause the display of the image subframes according to the adjusted duty cycles or adjusted illumination colors. In a case where the gamut mapping function (for example, as described in FIG. 8), the subframes to be displayed are generated based on the color subfields updated based on the adjusted gamut mapping function. If a duty cycle of a color subfield is adjusted, the output logic 410 can be configured to display each image subframe associated with that color subfield for a respective time slot determined based on the adjusted duty cycle. However, if the tristimulus values of an illumination color of a given color subfield has been adjusted, the output logic 410 can be configured to display each image subframe associated with that color subfield using light source intensities determined based on the adjusted tristimulus values. The output signals include signals indicative of state values of the display elements 310, electric current or voltage values for driving light sources, electric current or voltage values for driving electromechanical components of display elements, or other signals. For instance, the output signals can include a plurality of electric voltage (or current) values applied to the actuators 204 and 206 (shown in FIGS. 2A and 2B) for a plurality of display elements 150 through the interconnects 131-133 shown in FIG. 1B (or interconnects 110, 112 and 114 shown in FIG. 1A).

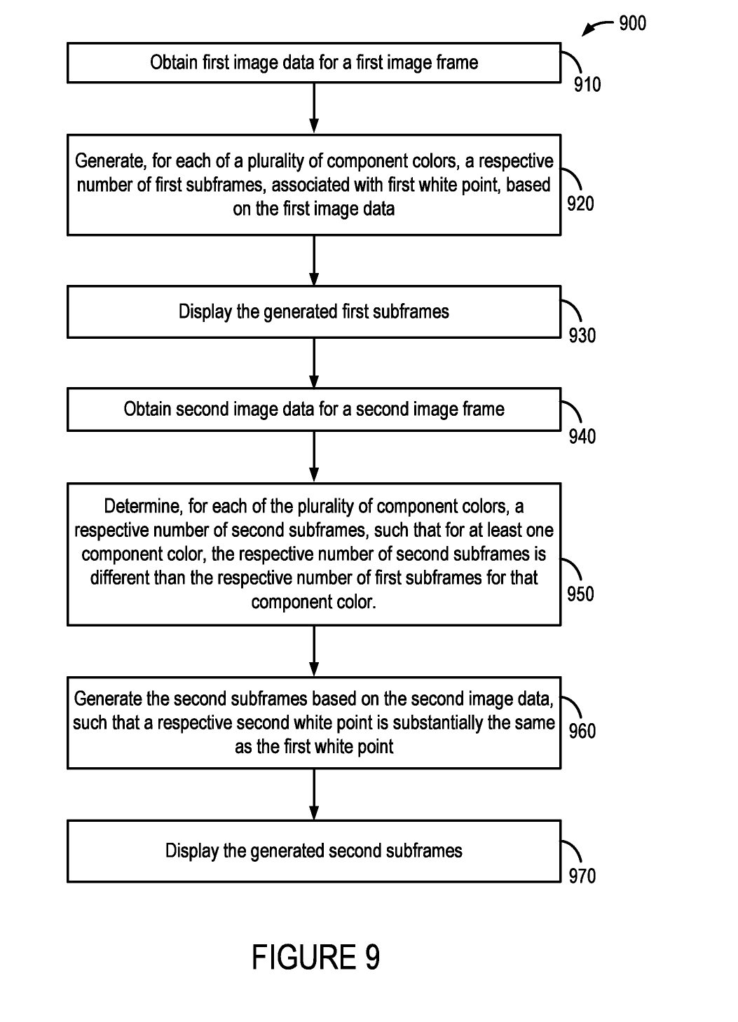

FIG. 9 shows a flow diagram of an example process 900 of displaying image frames while enforcing similar respective output white points. In some implementations, the process 900 can be carried out by the control logic 400 (shown in FIG. 4). The process 900 includes receiving first image data for a first image frame (stage 910), generating, for each of a plurality of component colors, a respective number of first subframes associated with a first output white point based on the first image data (stage 920), causing the generated first subframes to be displayed (stage 930), receiving second image data for a second image frame (stage 940), determining, for each of the plurality of component colors, a respective number of second subframes, such that for at least one component color, the respective number of second subframes is different than the respective number of first subframes for that component color (stage 950), generating the second subframes such that a respective second output white point is substantially the same as the first output white point (stage 960), and causing the generated second subframes to be displayed (stage 970). In some implementations, colors (or white points) are considered to be substantially the same if the Euclidean distance between such colors (or white points) in the (u′,v′) space is less than or equal to 0.02.

Referring at least to FIGS. 3, 4 and 9, the process 900 includes obtaining first image data for a first image frame (stage 910). For instance, the input logic 402 can obtain the first image data from the host device 302 or from a memory associated with display module 304 (or storage medium associated with display apparatus 128 of FIG. 1B). The input logic 402 can obtain the first image data as a stream of intensity values for the R, G, and B components of each pixel in the first image frame. The input logic 402 can receive the intensity values as binary numbers. In some implementations, the first image frame can be associated with a target color gamut such as sRGB, Adobe® RGB, or any other color gamut known in the art. As described above with regard to stage 510 of FIG. 5, the subfield derivation logic 404, or other logic incorporated into the control logic 400, can preprocess the first image data by applying a scaling process, a gamma correction process or a dithering process to the first image data.

The process 900 includes generating, for each of a plurality of component colors, a respective number of first subframes based on the first image data, such that at least two component colors are associated with different respective numbers of first subframes (stage 920). The generated first subframes are associated with a first output white point. As described herein, component colors refer to non-composite colors, for example, R, G and B. In some implementations, the first subframes can be generated as described above with respect to the processing stages 520-560 of FIG. 5. As discussed above, the adjustment of the display parameter(s) described in processing stage 540 of FIG. 5 can be performed according to any of the processes 600, 700 or 800 described above with regard to FIGS. 6A, 7 and 8, respectively. In some implementations, each component color can be associated with a respective first aggregate weight determined based on the first image data. In some implementations, at least two component colors are associated with different respective first aggregate weights. In some implementations, the subfield derivation logic 404 can also derive color subfields for composite colors and the subframe generation logic 408 can also generate subframes for such color subfields.

The output logic 410 can cause the generated first subframes to be displayed (stage 930). As described above with regard to stage 570 of FIG. 5, the output logic 410 can be configured to control output signals to a one or more components of the display apparatus 300 to cause the generated first subframes to be displayed.

The input logic 402 can obtain second image data for a second image frame (stage 940). In some implementations, the second image frame can be an image frame subsequent to the first image frame. In some implementations, the first and second image frames can be associated with a single target color gamut. The input logic 402 can obtain the second image data as described in stage 910 with respect to the first image data.

The process 900 can include determining, for each of the plurality of component colors, a respective number of second subframes, such that for at least one component color, the respective number of second subframes is different than the respective number of first subframes for that component color (stage 950). As described above with regard to stages 520 and 530 of FIG. 5, the subfield derivation logic 404 can derive a color subfield for each component color and determine for each color subfield a respective number of second subframes and a respective second aggregate weight based on the second image data. In some implementations, for at least one component color, the respective second aggregate weight is different than the respective first aggregate weight determined based on the first image data for the same component color. For example, the subfield generation logic 408 can generate four first subframes for the red based on the first image data and three second subframes for the red color based on the second image data. According to the same example, the aggregate weight for the red subfield derived based on the first image data can be 240 while the respective aggregate weight for the red subfield derived based on the second image data can be 224.

The process 900 can include generating the second subframes based on the second image data, such that a respective second output white point is substantially the same as the first output white point associated with the generated first subframes (stage 960). In some implementations, generating the second subframes can include performing processing stages 530-560 described above with regard to FIGS. 5, 6A, 6B, 7 and 8. That is, generating the second subframes can include the subfield derivation logic 404 or the output logic 410 adjusting (or determining) at least one display parameter to shift the second output white point towards the first output white point, towards a specific output white point or towards a white point associated with a target color gamut. For instance, the first and second image frames can be associated with the same target color gamut. Accordingly, the first and second output white points can be substantially the same. For instance, in some implementations, the Euclidean distance between the first and second white points in the (u′,v′) space can be less than or equal to 0.02.

In some implementations, the output logic 410 can adjust (or determine) at least one duty cycle associated with at least one component color in order to shift the second output white point towards the first output white point, towards a specific output white point or towards a white point associated with a target color gamut. In such implementations, the duty cycles of distinct component colors can be substantially equal. For instance, the final duty cycles (i.e., after adjustment) for separate component colors can be within a threshold difference from each other or from a target duty cycle. In some implementations, the threshold difference can be, for example, less than or equal to 1%.

In some implementations, duty cycle adjustment may not necessarily lead to duty cycles of separate component colors being substantially equal. For instance, in implementations where the duty cycles and the tristimulus values of the illumination light color(s) are both adjusted or in implementations where color subfields associated with composite colors other than white are employed, the final duty cycles for separate component colors can be substantially different. However, in some implementations, the final cumulative luminances (i.e., after adjustment of duty cycles and/or the tristimulus values of the respective illumination light colors) for separate component colors (such as C_{R,final}·Y_{R,final}, C_{G,final}·Y_{G,final} and C_{B,final}·Y_{B,final}) can be substantially equal, such as equal within 1% difference. The cumulative luminance for a given color subfield can be defined as the luminance intensity accumulated over a respective duty cycle. In implementations where color subfields associated with composite colors other than white are used, the cumulative luminance of each component color can be computed based on cumulative luminance(s) of one or more composite colors.

The output logic 410 can then cause the generated second subframes to be displayed (stage 970). As described above with regard to stage 570 of FIG. 5, the output logic 410 can be configured to control output signals to one or more components of the display apparatus 300 to cause the generated first subframes to be displayed.

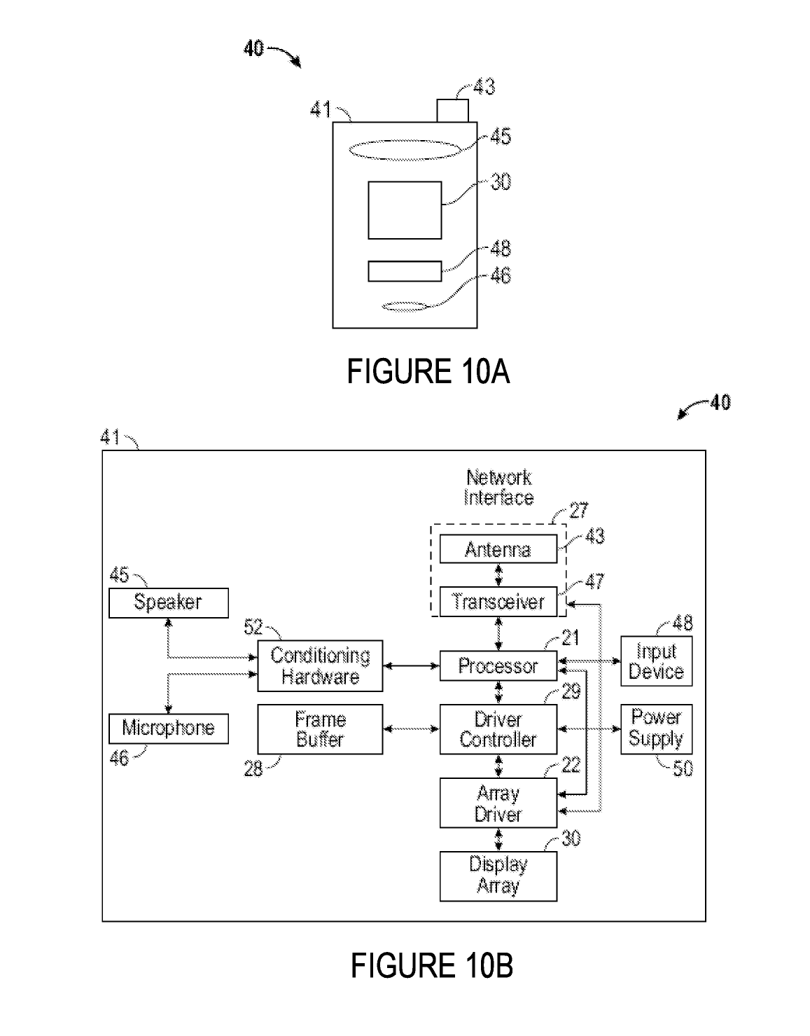

FIGS. 10A and 10B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 10B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 10A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A controller configured to:
receive first image data for a first image frame;
generate, for each of a plurality of component colors, a respective number of first subframes based on the first image data, wherein at least two component colors are associated with different respective numbers of first subframes, such that the generated first subframes are associated with a first output white point;
cause the generated first subframes to be displayed;
receive second image data for a second image frame;
determine, for each of the plurality of component colors, a respective number of second subframes, for at least one component color of the plurality of component colors, the respective number of second subframes is different than the respective number of first subframes for that component color;
generate the second subframes based on the second image data, such that a second output white point associated with the second image frame is substantially the same as the first output white point; and
cause the generated second subframes to be displayed.

2. The controller of claim 1, wherein for the generated second subframes, the plurality of component colors are associated with substantially equal respective duty cycles.

3. The controller of claim 1, wherein for the generated second subframes, the plurality of component colors are associated with substantially equal respective cumulative luminances.

4. The controller of claim 1, wherein generating the second subframes includes:
determining subframe weights for second subframes associated with each of the component colors, such that a first aggregate weight associated with a first component color is different than a second aggregate weight associated with a second component color;
adjusting at least one display parameter used to output the second image frame based on the first and second aggregate weights, such that the second output white point is shifted towards the first output white point; and
generating the second subframes according to the identified numbers of subframes and the identified subframe weights.

5. The controller of claim 4, wherein the at least one display parameter includes a duty cycle of the first component color.

6. The controller of claim 5, wherein adjusting the duty cycle of the first component color includes:
determining a cumulative duty cycle for the first component color based on the first aggregate weight;
determining a target cumulative duty cycle based on the first and second aggregate weights;
computing a scaling factor for the first component color based on the cumulative duty cycle for the first component color and the target cumulative duty cycle; and
determining display periods for second subframes associated with the first component color using the scaling factor.

7. The controller of claim 4, wherein the at least one display parameter includes at least a chromaticity or luminance of light used to illuminate the first component color.

8. The controller of claim 7, wherein adjusting a chromaticity or luminance of the contributing color associated with the first component color subfield:
obtaining tristimulus values for light used to illuminate the first component color;
computing a scaling factor based on the first and second aggregate weights;
adjusting the tristimulus values for the light used to illuminate the first component color using the scaling factor; and
identifying at least one light source intensity, for illuminating a second subframe associated with the first component color, based on the adjusted tristimulus values.

9. The controller of claim 4, wherein the at least one display parameter includes a gamut mapping function applied to the second image data.

10. The controller of claim 9, wherein adjusting the gamut mapping function includes:
determining tristimulus coordinates of the second output white point based on the first and second aggregate weights;
obtaining tristimulus coordinates of a target output white point;
computing scaling factors based on the tristimulus coordinates of the second output white point and the tristimulus coordinates of the target output white point; and
transforming the second image data using a transformation formed based on the scaling factors.

11. The controller of claim 1 comprising a processor capable of processing image data, the processor being capable of communicating with a memory device and a display including a plurality of display elements.

12. The controller of claim 11 being further capable of sending at least a portion of the image data to a driver circuit, the driver circuit being capable of sending at least one signal to the display.

13. The controller of claim 11, wherein the processor is capable of receiving the image data from an image source module and wherein the image source module includes at least one of a receiver, transceiver, and transmitter.

14. The controller of claim 13, wherein the processor is capable of receiving input data from an input device.

15. A non-transitory computer-readable medium comprising computer code instructions stored thereon, which when executed cause a processor to:
receive first image data for a first image frame;
generate, for each of a plurality of component colors, a respective number of first subframes based on the first image data, wherein at least two component colors are associated with different respective numbers of first subframes, such that the generated first subframes are associated with a first output white point;
cause the generated first subframes to be displayed;
receive second image data for a second image frame;
determine, for each of the plurality of component colors, a respective number of second subframes, for at least one component color of the plurality of component colors, the respective number of second subframes is different than the respective number of first subframes for that component color;
generate the second subframes based on the second image data, such that a second output white point associated with the second image frame is substantially the same as the first output white point; and
cause the generated second subframes to be displayed.

16. The computer-readable medium of claim 15, wherein for the generated second subframes, the plurality of component colors are associated with substantially equal respective duty cycles.

17. The computer-readable medium of claim 15, wherein for the generated second subframes, the plurality of component colors are associated with substantially equal respective cumulative luminances.

18. The computer-readable medium of claim 15, wherein generating the second subframes includes:
determining a number of subframes and subframe weights for each of the component colors, such that a first aggregate weight associated with a first component color is different than a second aggregate weight associated with a second component color;
adjusting at least one display parameter used to output the second image frame based on the first and second aggregate weights, such that the second output white point is shifted towards the first output white point; and
generating the second subframes according to the identified numbers of subframes and the identified subframe weights.

19. The computer-readable medium of claim 18, wherein the at least one display parameter includes a duty cycle of the first component color.

20. The computer-readable medium of claim 19, wherein adjusting the duty cycle of the first component color includes:
determining a cumulative duty cycle for the first component color based on the first aggregate weight;
determining a target cumulative duty cycle based on the first and second aggregate weights;
computing a scaling factor for the first component color based on the cumulative duty cycle for the first component color and the target cumulative duty cycle; and
determining display periods for second subframes associated with the first component color using the scaling factor.

21. The computer-readable medium of claim 18, wherein the at least one display parameter includes at least a chromaticity or luminance of light used to illuminate the first component color.

22. The computer-readable medium of claim 18, wherein the at least one display parameter includes a gamut mapping function applied to the second image data.

23. A method for forming an image frame, comprising:
receiving first image data for a first image frame;
generating, for each of a plurality of component colors, a respective number of first subframes based on the first image data, wherein at least two component colors are associated with different respective numbers of first subframes, such that the generated first subframes are associated with a first output white point;
causing the generated first subframes to be displayed;
receiving second image data for a second image frame;
determining, for each of the plurality of component colors, a respective number of second subframes, for at least one component color of the plurality of component colors, the respective number of second subframes is different than the respective number of first subframes for that component color;
generating the second subframes based on the second image data, such that a second output white point associated with the second image frame is substantially the same as the first output white point; and
causing the generated second subframes to be displayed.

24. The method of claim 23, wherein for the generated second subframes, the plurality of component colors are associated with substantially equal respective duty cycles.

25. The method of claim 23, wherein for the generated second subframes, the plurality of component colors are associated with substantially equal respective cumulative luminances.

26. The method of claim 23, wherein generating the second subframes includes:
determining a number of subframes and subframe weights for each of the component colors, such that a first aggregate weight associated with a first component color is different than a second aggregate weight associated with a second component color;
adjusting at least one display parameter used to output the second image frame based on the first and second aggregate weights, such that the second output white point is shifted towards the first output white point; and
generating the second subframes according to the identified numbers of subframes and the identified subframe weights.

27. The method of claim 26, wherein the at least one display parameter includes a duty cycle of the first component color.

28. The method of claim 27, wherein adjusting the duty cycle of the first component color includes:
determining a cumulative duty cycle for the first component color based on the first aggregate weight;
determining a target cumulative duty cycle based on the first and second aggregate weights;
computing a scaling factor for the first component color based on the cumulative duty cycle for the first component color and the target cumulative duty cycle; and
determining display periods for second subframes associated with the first component color using the scaling factor.

29. The method of claim 26, wherein the at least one display parameter includes at least a chromaticity or luminance of light used to illuminate the first component color.

30. The method of claim 26, wherein the at least one display parameter includes a gamut mapping function applied to the second image data.
